(19) United States
(12) Patent Application Publication
(10) Pub. No.: US 2009/0066845 A1
(43) Pub. Date: Mar. 12, 2009

(54) Content Processing Apparatus, Method of Processing Content, and Computer Program

(76) Inventor: Takao Okuda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/658,507

(22) PCT Filed: May 10, 2006
(86) PCT No.: PCT/JP2006/309378

§ 371 Date: Nov. 12, 2008

(30) Foreign Application Priority Data
May 26, 2005 (JP) 2005-153419
Apr. 11, 2006 (JP) 2006-108310

(51) Int. Cl. H04N 5/14; H04N 9/31

(52) U.S. Cl. 348/700; 348/744; 348/E05.062; 348/E09.025

(57) ABSTRACT

Switching of topics in video content is detected using a telop included in the image, and the content is segmented by topics.

First a scene-change point where the scene changes significantly is detected in the video content on the basis of the switching of images. Then, an average image of frames one second before and after the scene-change point is produced. The average image is used to detect, in a highly accurate manner, whether or not a telop is displayed. Then, a section in which the same stationary telop is displayed is detected. Index information related to the time period of each section in which the same stationary telop is displayed is produced.

### TECHNICAL FIELD

The present invention relates to a content processing apparatus configured to carry out processing, such as indexing, on video content obtained by, for example, recording a television program and relates to a method of processing content and a computer program. In particular, the present invention relates to a content processing apparatus configured to determine a scene change in the recorded television program on the basis of the subject (i.e., topic) of the television program and to carry out segmentation or categorization of the scenes and relates to a method of processing the content and a computer program.

More specifically, the present invention relates to a content processing apparatus configured to detect a topic change in video content on the basis of a telop included in the video content, to carry out segmentation of the video content on the basis of the detected topics, and to carry out indexing and relates to a method of processing the content and a computer program. In particular, the present invention relates to a content processing apparatus configured to detect a topic change on the basis of a relatively small amount of data by using a telop included in the video content and relates to a method of processing the content and a computer program.

### BACKGROUND ART

In today's information society, the importance of broadcasting is immeasurable. In particular, television broadcasting has a great impact to viewers since sound and images are directly transmitted to the viewers. Broadcasting technology includes a wide range of technologies, such as processing, transmitting, and receiving signals and processing audio and video information.

The household penetration rate of television sets is significantly high, and television programs broadcasted from various television stations are viewed by the general public. As another style of viewing broadcasted content, a viewer may record the content and playback the recorded content at any chosen time.

Recently, the advancement of digital technology has enabled massive amounts of audio video data to be stored. For example, a hard disk drive (HDD) having a capacity of several tens to several hundreds of gigabytes can be purchased relatively inexpensively, and HDD-based recording apparatuses and personal computers (PCs) capable of recording and playing television programs are available on the market. An HDD is a device that can be randomly accessed. Accordingly, when playing programs recorded on an HDD, the programs do not have to be played in the recorded order, such as for known video tapes, but any recorded program (or any scene or section in the program) can be directly played. A viewing mode in which a reception apparatus, such as a television set or a video recording and playing apparatus, receives and temporarily stores broadcasted content on a large storage device, such as a hard disk device, and then plays the stored content is referred to as “server broadcasting.” By using a server broadcasting system, unlike a regular television system, the viewer does not have to watch a broadcasted program at a time the program is broadcasted, and may watch the program at any selected time.

An increase in the hard disk capacity of the server broadcasting system has allowed viewers to record up to several tens of hours of television programs. However, it is substantially impossible for the viewer to watch the entire video content recorded on the hard disk. If it is possible for a viewer to retrieve only the scenes of interest and to carry out digest viewing, the viewer may be able to efficiently and effectively use the recorded content.

To carry out scene retrieval and digest viewing of the recorded content, indexing must be carried out on the images. As a method of video indexing, a method in which scene-change points corresponding to frames where the video signal greatly changes are detected and indexing is carried out is widely known.

For example, a scene change detection method for detecting that a scene of an image has changed when the sum of the differences of histograms representing components constituting an image corresponding to two consecutive image fields or image frames is greater than a predetermined threshold value is known (for example, refer to Patent Document 1). When forming histograms, constant numbers are assigned to a predetermined level and its adjacent level and are added; a new histogram is calculated by normalization; a change in a scene is detected in every two consecutive image fields or image frames by using the newly calculated histograms. In this way, a scene change can be accurately detected even in faded images.

Many scene-change points are included in a television program. In general, treating periods of time that correspond to specific subjects (i.e., topics) and segmenting and categorizing the video content is considered as being suitable for digest viewing. However, even while the same subject continues, the scenes change frequently. Therefore, a video indexing method depending only on scene-change points will not necessarily provide indexing desirable for the user.

A video sound content compiling apparatus configured to compile, retrieve, and select video contents according to index information by detecting a video cut position using video data, carrying out sound clustering using sound data, and carrying out indexing by integrating the video data and sound data has been proposed (for example, refer to Patent Document 2). According to this video sound content compiling apparatus, index information (for distinguishing sound, no sound, and music) obtained from audio information is linked with scene-change points. In this way, sections of meaningful images and sound may be detected as scenes and less meaningful scene-change points can be ignored. However, since many scene-change points exist in one television program, video content cannot be segmented on the basis of different topics.

In general, as a method of producing and editing television broadcasting, such as news programs and variety programs, a method of displaying telops explicitly or implicitly representing the subject of the program in the corners of the image frames is employed. A telop displayed in an image frame can be used as a significant clue for specifying or estimating the topic the broadcasted program in the display period of the telop. Accordingly, extracting a telop from the video content and carrying out video indexing in which displayed content of the telop is defined as one index.

For example, a broadcast program content menu production apparatus configured to detect telops included in image frames, as characteristic image sections of the image frames, and to automatically produce a menu representing the content of the broadcast program by extracting image data corresponding to only the telops has been proposed (for example, refer to Patent Document 3). To detect a telop in a frame, usually, edge detection must be carried out. However, edge computation imposes a high processing load. For the apparatus to carry out edge detection for each image frame, a great computational effort is required. Furthermore, a main object of the apparatus is to automatically produce a program menu of a news program using telops extracted from video data and is not to specify a change in topic in the news program on the basis of detected telops or to add an image index using a topic. In other words, a solution to the problem of carrying out image indexing on the basis of the information on telops detected in image frames is not provided.

[Patent Document 1]

Japanese Unexamined Patent Application Publication No.

[Patent Document 2]

Japanese Unexamined Patent Application Publication No.

[Patent Document 3]

Japanese Unexamined Patent Application Publication No.

### DISCLOSURE OF INVENTION

An object of the present invention is to provide an excellent content processing apparatus capable of suitably carrying out video indexing of the recorded video content by determining a scene change on the basis of the subject (i.e., topic) of the program and to segment the video content into scenes and to provide a method of processing the content and a computer program.

Another object of the present invention is to provide an excellent content processing apparatus configured to detect a topic change in the video content by using telops included in the image, to segment the content by each topic, and to carry out indexing and to provide a method of processing the content and a computer program.

Another object of the present invention is to provide an excellent content processing apparatus configured to detect a subject change on the basis of a relatively small amount of data by using a telop included in the video content and to provide a method of processing the content and a computer program.

By taking into consideration the above-identified problems, a first aspect of the present invention provides a content processing apparatus configured to process video content data including chronologically ordered image frames includes a scene-change detection unit configured to detect, in the video content to be processed, a scene-change point that is a point between two image frames where the scene of one image frame is significantly different from the scene of the other image frame, a topic detection unit configured to detect, in the video content to be processed, a section that corresponds to a topic and a plurality of consecutive image frames in whose telop areas the same stationary telop is displayed, and an index storage unit configured to store index information indicating a time period corresponding to the section detected by the topic detection unit.

It has become common to receive and temporarily store broadcasted content such as television programs in a reception apparatus and then play the content. An increase in the capacity of hard disks has enabled television programs corresponding to several tens of hours to be recorded. Accordingly, it is effective to retrieve only scenes that interest the viewers from the recorded content and to allow the viewers to carry out digest viewing. To enable scene retrieval and digest viewing of recorded content, images must be indexed.

Conventionally, a method of indexing by detecting a scene-change point from video content has been well known. However, since many scene-change points are included in a television program, the indexing was not necessarily optimal for the viewer.

For broadcasted television programs, such as new programs and variety programs, telops representing the topic of the program are often displayed in the four corners of the image frames. Therefore, the telops can be extracted from the video content and display content of the telops can used as an index. However, to extract telops from video content, edge detection processing must be carried out for each image frame. This is a problem since a massive amount of computation must be carried out.

Accordingly, the content processing apparatus according to the present invention first detects a scene-change point included in a video content to be processed and then detects whether or not a telop is displayed in the image frames immediately before and after the scene-change point. If a telop is detected, a section in which the same stationary telop is displayed is detected. In this way, the amount of edge detection processing to be carried out for extracting the telop is minimized, reducing the processing load applied for detecting a topic.

The topic detection unit produces an average image of image frames, for example, corresponding to a period of one second before and after the scene-change point and detects a telop included in the average image. If a telop is continuously displayed before and after the scene-change point, the telop portion will remain clear in the average image and the other portions will be blurry. In this way, the accuracy of telop detection can be improved. Telop detection is possible by carrying out, for example, edge detection.

The topic detection unit compares a telop detected in the average image with the telop displayed in the telop areas of image frames before the scene-change point in the section in which the same stationary telop is displayed and defines the point where the telop disappears as a start point of a topic. Similarly, the topic detection unit compares the telop detected in the average image with the telop displayed in the telop areas of image frames after the scene-change point in the section in which the same stationary telop is displayed and defines the point where the telop disappears as an end point of the topic. Whether or not the telop has disappeared from the telop area can be determined by a small processing load by computing the average color for each color component in the telop area of each of the image frames being compared with the telop detected in the average image so as to determine whether or not the Euclidean distance between the average colors between the image frames exceeds a predetermined threshold value. Of course, the point where the telop disappears can be detected even more accurately by employing a known method of detecting a scene change.

However, there is a problem in that, when the average colors are calculated within the telop area, the effect of the background colors other than the telop included in the telop area is great. Thus, as an alternative method, a method of determining whether or not a telop is present using edge information is proposed. In other words, edge images in the telop area of the frames to be compared is determined, and the presence of a telop in the telop area is determined on the basis of the comparison result of the edge images in the telop area of the frames. More specifically, edge images in the telop area of the frames to be compared is determined, and it is determines that a telop has disappeared when the number of pixels in an edge images detected the telop area decreases significantly, whereas it is determined that the telop continues to be displayed when the change in the number of pixels is small. Moreover, when the number of pixels of an edge image increases significantly this can be determined as a new telop appearing.

The number of edge images may not change very much when the telop changes. Even when the change in the number of pixels of the edge image in the telop area among frames is small, the change in the telop, i.e., the start and end positions of the telop, can be estimated when a logical AND for each edge pixel corresponding to each edge image and, as a result, the number of edge pixels in the image significantly decreases (for example, one-third or less).

The topic detection unit determines the length of the section on the basis of the start point and the end point, and, if the length of the section is longer than a predetermined amount of time, the section is determined to correspond to a predetermined topic. In this way, false detection can be prevented.

The topic detection unit may determine whether the telop is a necessary telop on the basis of the size of the telop area in which the telop is detected in the frame and the position information. The position where the telop appears and the size of the telop in the image frame are determined in accordance with a general established practice of the broadcasting business. By detecting telops by referring to the position where the telop appears and the size of the telop in the image frame on the basis of this established practice, false detection can be reduced.

A second aspect of the present invention provides a computer program written in a format readable by a computer so as to carry out processing on video content including chronologically ordered image frames on a computer system includes the steps of detecting, in the video content to be processed, a scene-change point that is a point between two image frames where the scene of one image frame is significantly different from the scene of the other image frame, detecting a section in the video content to be processed corresponding to a plurality of consecutive image frames in whose telop areas the same stationary telop is displayed on the basis of image frames immediately before and after the scene-change point detected in the step of detecting a scene-change point to detect whether or not a telop is displayed in the telop areas of the image frames, storing index information indicating a time period corresponding to the section detected in the step of detecting a section, and playing a section of the video content corresponding to a start time and an end time represented by the index information when a topic is selected from the index information stored in the storing step.

The computer program according to the second aspect of the present invention defines a computer program written in a computer-readable format so as to carry out predetermined processing in a computer system. In other words, by installing the computer program according to the second aspect of the present invention to a computer system, cooperative operation is carried out on the computer system such that the same operation as the content processing apparatus according to the first aspect of the present invention may be achieved.

The present invention provides an excellent content processing apparatus configured to detect a topic change in the video content on the basis of a telop included in the video content, to carry out segmentation of the video content on the basis of the detected topics and to carry out indexing and provides a method of processing the content and a computer program.

The present invention provides an excellent content processing apparatus configured to detect a subject change on the basis of a relatively small amount of data by using a telop included in the video content and provides a method of processing the content and a computer program.

According to the present invention, for example, a recorded television program may be segmented on the basis of topics. By segmenting a television program by topics and adding indexes, the user may view television programs in an efficient manner such as digest viewing. The user may check, for example, the beginning of the topic when replaying the recorded content, and, if the topic does not interest them, the user may skip to the next topic. Furthermore, when storing the recorded video content on a DVD, editing operation, such as storing only selected topics, is easy.

Other objects and advantages of the present invention will be described in detail below with reference to drawings.

### BRIEF DESCRIPTION OF THE DRAWINGS

FIG. 1 illustrates a schematic view of the functional structure of a video content processing apparatus according to an embodiment of the present invention; and

FIG. 2 illustrates a schematic view of telop areas included in an example screen of a television program;

FIG. 3 illustrates a flow chart of a topic detection process for detecting a section of video content in which the same stationary telop is displayed;

FIG. 4 illustrates a method of detecting a telop in an averaged image obtained from images immediately before and after a scene-change point;

FIG. 5 illustrates a method of detecting a telop in an averaged image obtained from images immediately before and after a scene-change point;

FIG. 6 illustrates a method of detecting a telop in an averaged image obtained from images immediately before and after a scene-change point; and

FIG. 7 illustrates a method of detecting a telop in an averaged image obtained from images immediately before and after a scene-change point.

FIG. 8 illustrates an example of the structure of a telop detection area in an image frame having an aspect ratio of 720×480 pixels.

FIG. 9 illustrates the condition of detecting the start position of a topic from a frame sequence.

FIG. 10 illustrates a flow chart showing the process of detecting the start position of a topic from a frame sequence.

FIG. 11 illustrates the condition of detecting the end position of a topic from a frame sequence.

FIG. 12 illustrates a flow chart showing the process of detecting the end position of a topic from a frame sequence.

### REFERENCE NUMERALS

10 video content processing apparatus
11 image storage unit
12 scene-change detection unit
13 topic detection unit
14 index storage unit
15 playing unit

### BEST MODE FOR CARRYING OUT THE INVENTION

Embodiments of the present invention will be described in detail with reference to the drawings.

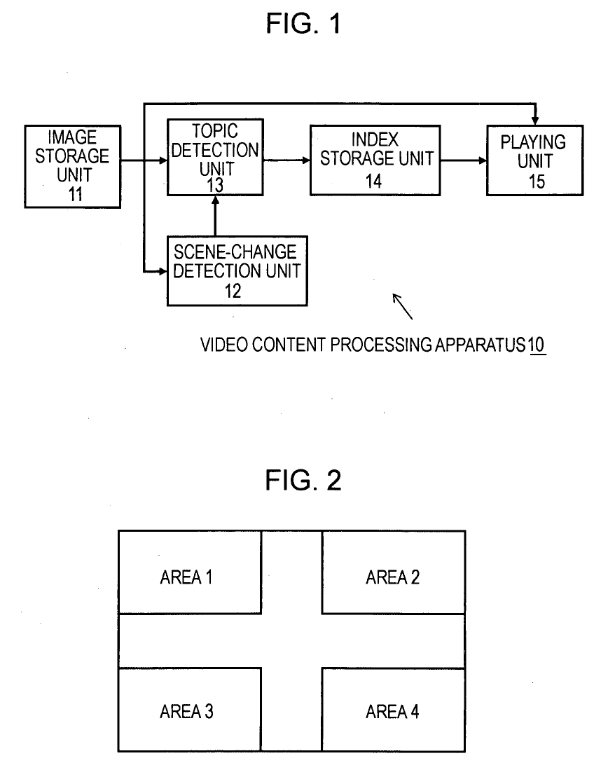

FIG. 1 illustrates a schematic view of the functional structure of a video content processing apparatus 10 according to an embodiment of the present invention. The video content processing apparatus 10, shown in the drawing, includes an image storage unit 11, a scene-change detection unit 12, a topic detection unit 13, an index storage unit 14, and a playing unit 15.

The image storage unit 11 demodulates and stores broadcast waves and stores video content downloaded from an information source via the Internet. For example, the image storage unit 11 may be constituted of a hard disk recorder.

The scene-change detection unit 12 retrieves video content subjected to topic detection from the image storage unit 11, tracks a scene (scene or scenery) included in consecutive image frames, and detects a scene-change point where the scene changes significantly due to switching of the image.

For example, the image storage unit 11 may employ a method of detecting a scene change that is disclosed in Japanese Unexamined Patent Application Publication No. 2004-282318, which has already been transferred to the assignee. More specifically, a scene-change point is determined by producing histograms representing the image components of two consecutive fields or frames, and detecting a change in the scene when the calculated sum of the differences of the histograms is greater than a predetermined threshold value. When producing the histograms, constant numbers are assigned to the corresponding level and its adjacent levels and are added. Then, by normalization, a result of another histogram is calculated. By using these newly produced histograms, a scene change can be detected in every two images on the screen. Consequently, a scene change can be accurately detected even in faded images.

The topic detection unit 12 detects a section in which the same stationary telop is displayed in video content subjected to topic detection and outputs the detected section as a section in a television program that corresponds to a specific topic.

In television programs, such as news programs and variety programs, telops displayed in the image frames can be used as significant clues for specifying or estimating the topic of sections in the television program in which the telop is displayed. However, the amount of computation required for detecting and extracting telops is massive. Therefore, according to the this embodiment, a section in which the same stationary telop is displayed is detected on the basis of a scene-change point detected in video content in a manner such as to reduce the number of image frames on which edge detection must be carried out as much as possible. The section in which the same stationary telop is displayed can be regarded as a section in a television program that corresponds to a specific topic. This section can be suitably handled as a single block when carrying out segmentation of the video content, indexing, and digest viewing. Details of topic detection processing will be described below.

The index storage unit 14 stores time information related to each section in which the same stationary telop is displayed detected by the image storage unit 11. The following table shows an example configuration of time information stored in the index storage unit 14. In the table, a record for each of the detected sections is provided. In each record, the title of a topic corresponding to the section, the start time of the section, and the end time of the section are recorded. For example, index information can be written in a standard structured descriptive language, such as extensible markup language (XML). The title of the topic may be the title of the video content (or the television program) or the character information of the displayed telop.

TABLE 1

| Content Name | Start Time [sec] | End Time [sec] |
|---|---|---|
| Video 1 | 20 | 45 |
| | 60 | 80 |
| Video 2 | 10 | 25 |
| | 30 | 45 |
| . . . | . . . | . . . |

The playing unit 15 retrieves video content that is instructed to be played from the image storage unit 11 and decodes and demodulates the retrieved video content so as to output the video content as images and sound. According to this embodiment, the playing unit 15 retrieves suitable index information on the basis of the content name from the index storage unit 14 so as to play the video content and links the index information to the video content. For example, when a topic is selected from the index information managed by the index storage unit 14, the corresponding video content is retrieved from the image storage unit 11 and the section from the start time to the end time indicated by the index information is played.

Next, the topic detection processing carried out by the topic detection unit 13 to detect a section in which the same stationary telop is displayed in the video content will be described in detail.

According to this embodiment, frames immediately before and after a scene-change point detected by the scene-change detection unit 12 are used to detect whether or not a telop is displayed in the image frames. When a displayed telop is detected, the edge detection processing for extracting the telop can be minimized since the section in which the same stationary telop is displayed is detected. Therefore, the processing load applied when detecting a topic can be reduced.

For example, in television programs in various genres, such as news programs and variety programs, telops are displayed to gain understanding and support, to generate interest, or to draw attention from the viewers. In many cases, a stationary telop is displayed in one of the four areas in the screen, as shown in FIG. 2. In general, a stationary telop has the following characteristics.

1) functions as a representation of the subject of the broadcasted television program (a title and the like);

2) is continuously displayed while the television program is on the same subject.

For example, in a news program, while a specific news item is being broadcasted, a title of the news item may be continuously displayed. The topic detection unit 13 detects such a section of the program in which a stationary telop is displayed and adds an index to the detected section that corresponds to a specific topic. The topic detection unit 13 is also capable of producing a thumbnail of the detected stationary telop or recognizing the characters of the displayed telop to obtain character information corresponding to the title of the specific topic.

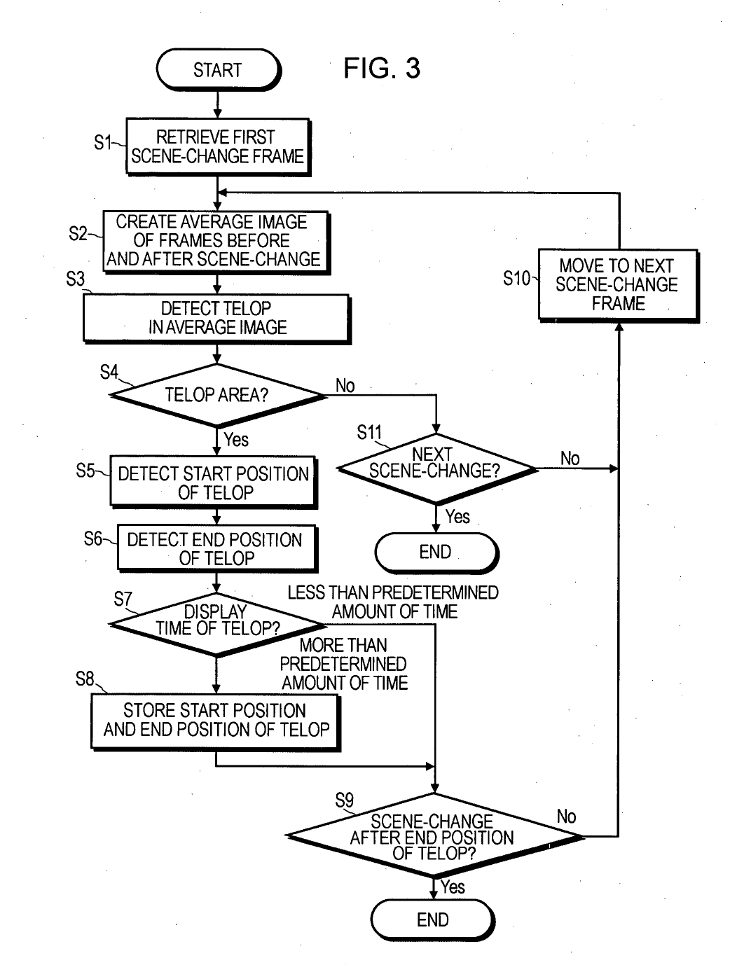

FIG. 3 illustrates a flow chart showing the topic detection processing carried out by the topic detection unit 13 to detect a section of video content in which the same stationary telop is displayed.

First, an image frame at the first scene-change point is retrieved from the video content that is to be processed (Step S1). An average image is produced from image frames corresponding to one second before and one second after the scene-change point (Step S2). Then, telop detection is carried out on the average image (Step S3). If the telop continues to be displayed before and after the scene-change point, the telop portion of the average image will remain clear and the other portions will be blurry. Accordingly, the detection accuracy of the telop can be improved. The image frames used for generating an average image are not limited to the image frames one second before and after the scene-change point. So long as the image frames used to obtain an average image are taken from points before and after the scene-change point, more than two image frames may be used.

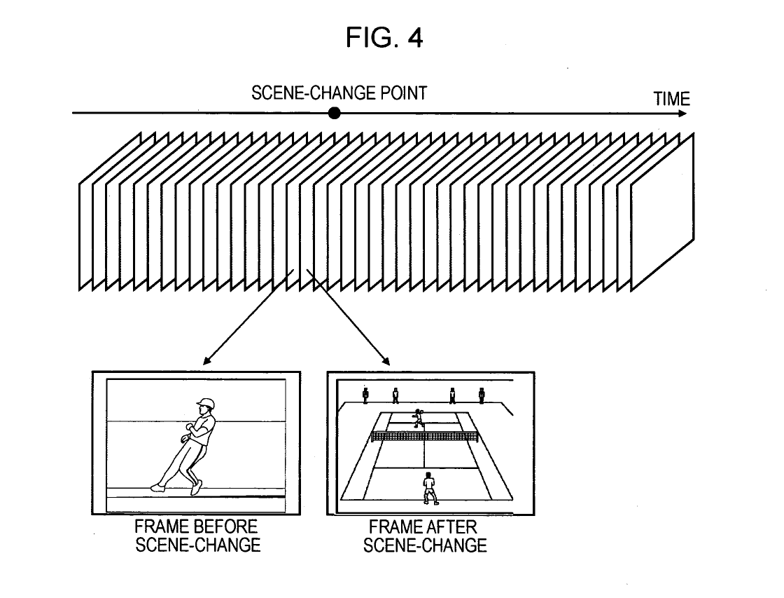

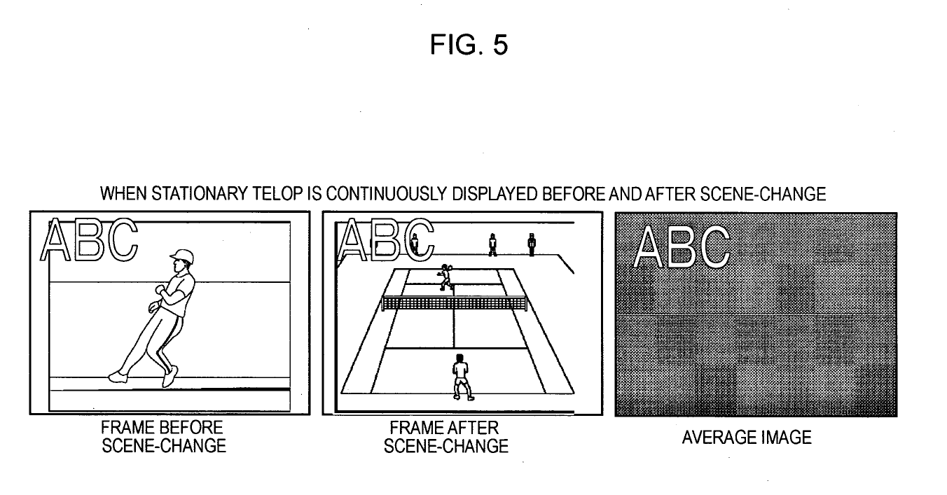

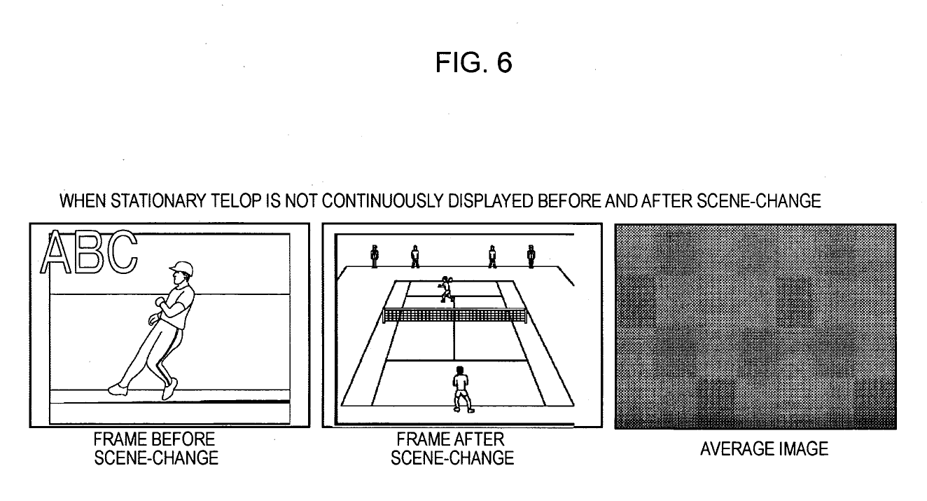

FIGS. 4 to 6 illustrate the process of detecting a telop from an average image generated from image frames before and after a scene-change point. Since the scene of one image frame changes significantly from the scene of the other image frame, an image obtained by averaging the two image frames is blurry as though the image frames are alpha blended. If the same stationary telop continues to be displayed before and after the scene-change point, as shown in FIG. 5, the telop portion of the averaged image remains clear and stands out from the blurry background. Accordingly, the telop can be extracted in a highly accurate manner by carrying out edge detection processing. If a telop is displayed only in one of the image frames before and after the scene-change point (or if the telop displayed in one image frames differs from the telop displayed in the other frame), as shown in FIG. 6, the telop portion of the average image will be blurry in the same way as the background. In this way, a telop is not mistakenly detected.

In general, the brightness of a telop is greater than that of the background. Therefore, a method of detecting a telop using edge information can be employed. For example, YUV conversion is carried out on an input image, and, then, edge computation is carried out on the Y component. To carry out edge computation, a telop information processing method described in Japanese Unexamined Patent Application Publication No. 2004-343352, which is already transferred to the assignee, or an artificial image extraction method described in Japanese Unexamined Patent Application Publication No. 2004-318256 may be employed.

If a telop is detected from the average image (Step S4), the rectangular area satisfying the following conditions is determined as an actual telop.

1) an area larger than a predetermined area (e.g., larger than 80×30 pixels)

2) an area that does not overlap with more than one telop area (refer to FIG. 2)

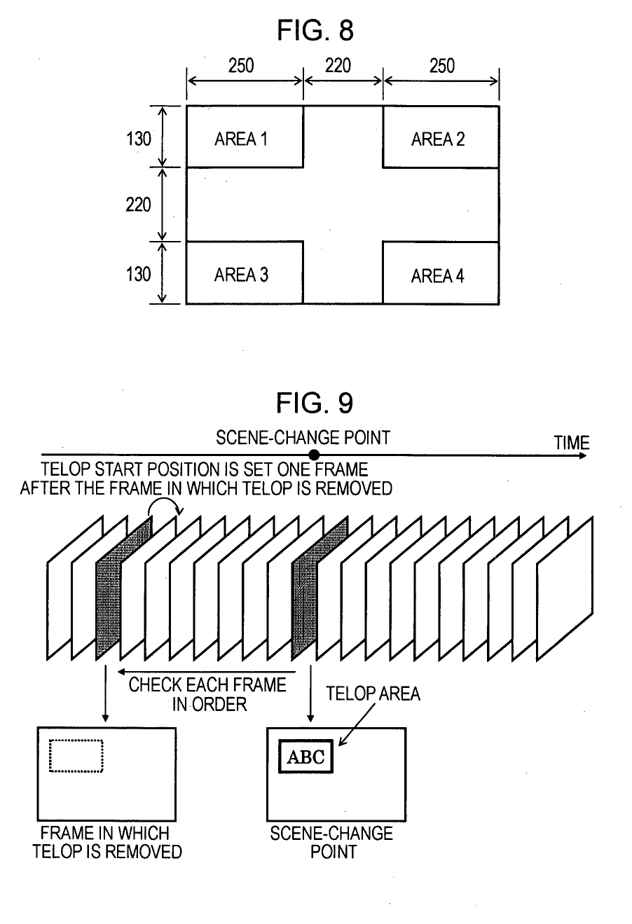

The position where the telop appears and the size of the telop in the image frame are determined in accordance with a general established practice of the broadcasting business. By detecting telops by referring to the position where the telop appears and the size of the telop in the image frame on the basis of this established practice, false detection can be reduced. FIG. 8 illustrates an example of the structure of a telop detection area in an image frame having an aspect ratio of 720×480 pixels.

When a telop is detected, the telop area of the detected telop is compared, one by one in order, with the telop area in the image frames before the scene-change point. The image frame immediately after the image frame in which the telop disappears from the telop area is determined as the start point of a section corresponding to a specific topic (Step S5).

FIG. 9 illustrates the condition of detecting the start position of a topic from a frame sequence in Step S5. As shown in the drawing, comparison of the telop areas is carried out from the scene-change point where the telop was detected in Step S3 to the forward direction in order for each frame. Then, when the frame in which the telop disappears from the telop area is detected, the frame immediately before is detected as the start position of the topic.

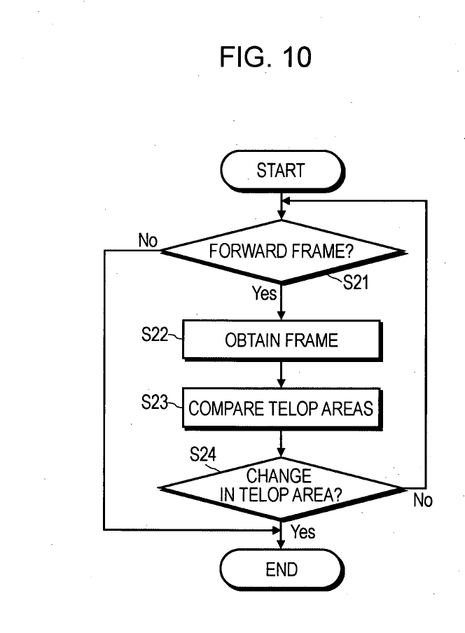

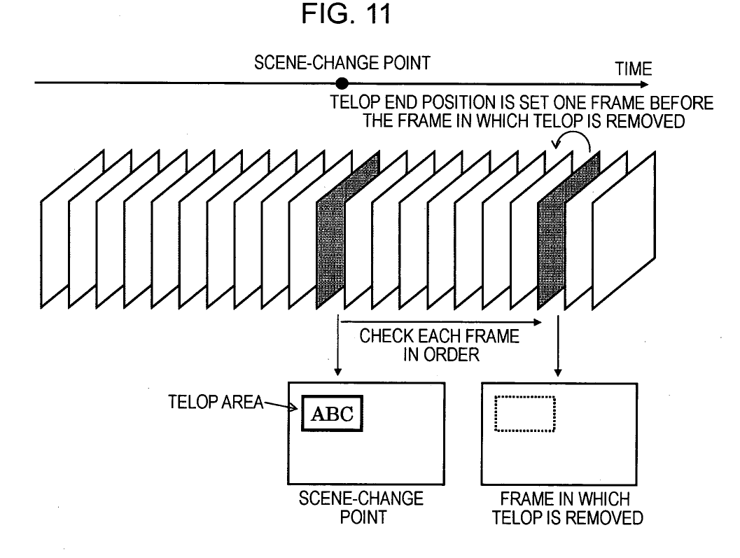

In FIG. 10, the process of detecting the start position of a topic from a frame sequence is shown in a flow chart. First, when a frame is present before the current frame position (Step S21), that frame is obtained (Step S22), and the telop areas of the frames are compared (Step S23). Then, if there is no change in the telop areas (“No” in Step S24), the telop is continuously displayed. Thus, the process returns to Step S21 to repeat the above-described process. If there is a change in the telop area (“Yes” in Step S24), the telop has disappeared. Thus, a frame immediately before that frame is output as the start position of the topic, and the process routine is completed.

Similarly, the telop area of the detected telop is compared, one by one in order, with the telop area in the image frames after the scene-change point. The image frame immediately before the image frame in which the telop disappears from the telop area is determined as the end point of a section corresponding to a specific topic (Step S6).

FIG. 11 illustrates the condition of detecting the end position of a topic from a frame sequence. As shown in the drawing, comparison of the telop areas is carried out from the scene-change point where the telop was detected in Step S3 to the forward direction in order for each frame. Then, when the frame in which the telop disappears from the telop area is detected, the frame immediately after is detected as the end position of the topic.

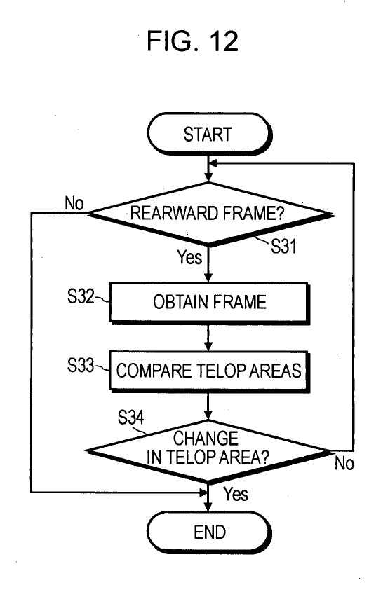

FIG. 12 illustrates a flow chart showing the process of detecting the end position of a topic from a frame sequence. First, when a frame is present after the current frame position (Step S31), that frame is obtained (Step S32), and the telop areas of the frames are compared (Step S33). Then, if there is no change in the telop areas (“No” in Step S34), the telop is continuously displayed. Thus, the process returns to Step S31 to repeat the above-described process. If there is a change in the telop area (“Yes” in Step S34), the telop has disappeared. Thus, a frame immediately before that frame is output as the start position of the topic, and the process routine is completed.

When detecting the telop disappearing position of the as shown in FIGS. 9 and 11, the position from where the telop has disappeared can be accurately detected by comparing, one by one, the telop areas of frames forward and rearward from the scene-change point, which is the start position, in order. To reduce the processing load, the approximate position where the telop disappears can be detected by the following steps.

1) compare I pictures in a coded image, such as MPEG, including alternately arranged I pictures (intra-frame coded images) and a plurality of P pictures (inter-frame forward predictive coded image)

2) compare image frames every second

Whether or not a telop has disappeared from a telop area can be determined by, for example, calculating the average colors of the RGB components of the telop area of the image frames being compared and determining whether or not the Euclidean distances of the average colors between the image frames exceed predetermined threshold values. In this way, whether or not the telop disappears can be determined while requiring only a small processing load. In other words, it is determined that the telop has disappeared at the nth image frame before or after the scene-change point that satisfies the following formula (I) where R0_{avg}, G0_{avg}, and B0_{avg} represent the average colors (i.e., averages of the RGB components) of the telop area in a image frame at the scene-change point, Rn_{avg}, Gn_{avg}, and Bn_{avg} represent the average colors of the telop area in the nth image frame from the scene-change point. The threshold value is, for example, 60.

$$\sqrt{\begin{matrix}{( {RN}_{avg} - R {0}_{avg} )}^{2} + {( {GN}_{avg} - G {0}_{avg} )}^{2} + \\ {( {BN}_{avg} - B {0}_{avg} )}^{2}\end{matrix}} > threshold value \qquad ( 1 )$$

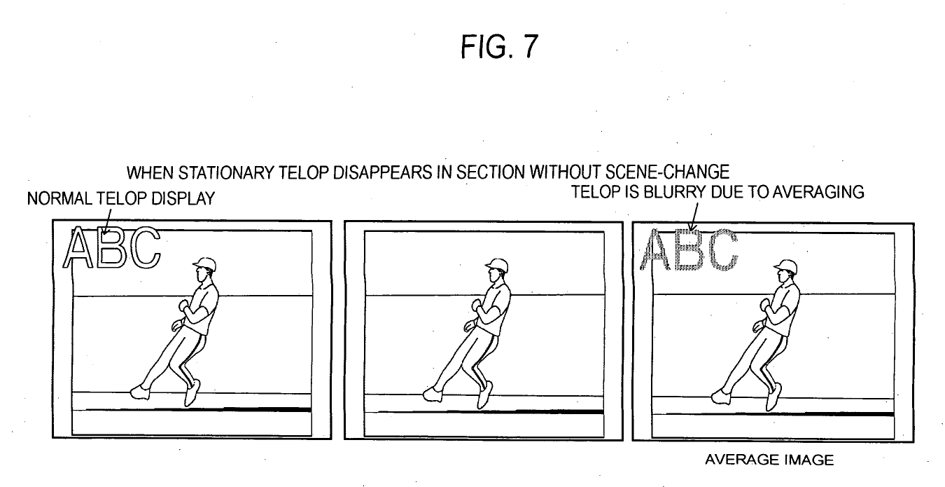

When the stationary telop disappears in a section where a scene change does not occur, the average image will include a clear background but the telop will be blurry, as shown in FIG. 7. In other words, the result is opposite to that shown in FIG. 5. This is also the same when a stationary telop appears in a section where a scene change does not occur. To more accurately detect the point in which the telop disappears, the method of detecting a scene change disclosed in Japanese Unexamined Patent Application Publication No. 2004-282318 may be employed to the telop area.

Here, there is a problem in that, when the average colors are calculated within the telop area, the effect of the background colors other than the telop included in the telop area is great, reducing the detection accuracy. Thus, as an alternative method, a method of determining whether or not a telop is present using edge information is proposed. In other words, edge images in the telop area of the frames to be compared is determined, and the presence of a telop in the telop area is determined on the basis of the comparison result of the edge images in the telop area of the frames. More specifically, edge images in the telop area of the frames to be compared is determined, and it can be determines that a telop has disappeared when the number of pixels in an edge images detected the telop area decreases significantly. In contrast, it can be determined that the telop continues to be displayed when the change in the number of pixels is small.

For example, SC represents a scene-change point, Rect represents a telop area at SC, and EdgeImg1 represents an edge image of Rect at SC. EdgeImgN represents an edge image in the telop area Rect of the nth from count from the SC (toward the beginning or the end of the time axis). The edge image is binarized by a predetermined threshold value (for example, 128). In Step S23 in the flow chart shown in FIG. 10 and in Step s33 in the flow chart shown in FIG. 12, the numbers of edge points (number of pixels) of EdgeImg1 and EdgeImgN are compared. When the number of edge points decrease significantly (for example, one-third or less), it can be estimated that the telop has disappeared (whereas, when the number of edge points increase significantly, it can be estimated that a telop has appeared).

When the number of edge point do not differ very much at EdgeImg1 and EdgeImgN, it can be estimated that the telop continues to be displayed. However, there is a possibility that that telop has changed even though the number of edge points has not changed very much. Thus, when the logical AND for each pixel in the EdgeImg1 and EdgeImgN is obtained and the number of edge points in the result image decreases significantly (for example, one-third or less), it is estimated that the telop has changed, i.e., it is the start or end position of the telop. In this way, the detection accuracy can be improved.

Subsequently, the telop start point determined in Step S5 is subtracted from the telop end point determined in Step S6 to determine the telop display time. Then, by the telop display time is determined as a section corresponding to a specific topic (Step S7) only when the telop is displayed for a predetermined amount of time, the possibility of false detection can be reduced. It is also possible to obtain genre information on a television program from an electric program guide (EPG), and change the threshold value of the telop display time depending on the genre. For example, since for a news program, the telop display time is relatively long, the threshold value may be set to 30 seconds, whereas, for a variety program, the threshold value may be set to 10 seconds.

The telop start point and end point cognized as a section corresponding to a specific topic in Step S7 is stored in the index storage unit 14 (Step S8).

The topic detection unit 13 contacts the scene-change detection unit 12 to confirm whether or not the video content includes a scene-change point after the telop end point detected in Step S6 (Step S9). When a scene-change point is not found after the telop end point, the entire processing routine is completed. When a scene-change point is found after the telop end point, the frame of the next scene-change point is retrieved (Step S10), the process returns to Step S2, and the above-described topic detection process is repeated.

In Step S4, when a telop is not detected at a scene-change point to be processed, the topic detection unit 13 contacts the scene-change detection unit 12 to confirm whether a subsequent scene-change point is included in the video content (Step S11). When a subsequent scene-change point is not included, the entire processing routine is completed. In contrast, when a subsequent scene-change point is included, the frame of the next scene-change point is retrieved (Step S10), the process returns to Step S2, and the above-described topic detection process is repeated.

According to the present embodiment, a telop detection process is carried out on the assumption that telop areas are provided at the four corners of the television screen, as shown in FIG. 2. In many television programs, however, the current time is constantly displayed in one of these areas. To prevent false detection, character information of the detected telop may be obtained, and if the characters are recognized as numbers, the detected telop may be determined as not being an actual telop.

In some cases, a telop may disappear from the screen, and several seconds after, the same telop may reappear. In such a case, an extra index may be prevented from being generated even when the telop display is discontinuous, i.e., the telop display is interrupted by regarding this as a continuous telop display (i.e., the same topic continuing) when the flowing conditions are satisfied.

1) Formula I is satisfied in the telop area before the telop disappears and after the telop reappears

2) in the telop areas before the telop disappears and after the telop reappears, the numbers of pixel of the edge images are substantially the same and the number of pixels of the edge images is substantially the same when the logical AND for each pixel corresponding in the edge images is obtained

3) the amount of time the telop disappears is equal to or less than the threshold value (e.g., five seconds)

For example, genre information on a television program may be obtained from an EPG so that the threshold value of the interruption time may be changed depending on the genre of the television program, such as a news program or a variety program.

### INDUSTRIAL APPLICABILITY

In the above, the present invention has been described in detail with reference to specific embodiments. However, it is obvious that one skilled in the art may modify or alter the embodiments within the scope of the present invention.

In this specification, a case in which indexing is carried out to video content mainly obtained by recording television programs, but the gist of the present invention is not limited. The content processing apparatus according to the present invention can suitably carry out indexing of various video content that is produced and compiled for use other than television broadcasting and that includes a telop area representing a topic.

In essence, the present invention has been disclosed in the form of examples, and the content described in this specification should not be interpreted with limitations. The essence of the present invention should be inferred from the scope of the following claims.

1. A content processing apparatus for processing video content including time-sequential image frames, the apparatus comprising:
a scene-change detection unit for detecting a scene-change point in the video content to be processed, the scene-change point being a point where a scene significantly changes due to switching of frames;
a topic detection unit for detecting a section in the video content to be processed, the section being a plurality of consecutive image frames in which the same stationary telop appears; and
an index storage unit for storing index information related to the time of the section in which the same stationary telop appears detected by the topic detection unit,
wherein the topic detection unit uses frames immediately before and after the scene-change point detected by the scene-change detection unit so as to detect whether or not a telop appears at corresponding positions.

2. The content processing apparatus according to claim 1, further comprising:
a playing unit for linking the index information managed at the index storage unit and the video content when playing the video content.

3. The content processing apparatus according to claim 2, wherein, when a topic is selected from the index information managed at the index storage unit, the playing unit plays and outputs a section of the corresponding video content from a start time to an end time represented by the index information in the video content.

4. (canceled)

5. The content processing apparatus according to claim 1, wherein the topic detection unit produces an average image of frames in a predetermined period of time before and after the scene-change point and carries out telop detection on the average image.

6. The content processing apparatus according to claim 5, wherein the topic detection unit
compares telop areas of frames forward of the scene-change point and detects a frame immediately after the frame in which the telop disappears from the telop area as a start position of a topic and
compares telop areas of frames rearward of the scene-change point and detects a frame immediately before the frame in which the telop disappears from the telop area as a end position of the topic.

7. The content processing apparatus according to claim 6, wherein the topic detection unit computes the average color for each color component in the telop area of each frame to be compared and determines the telop has disappeared from the telop area by determining whether or not the Euclidean distance of the average colors between the image frames exceeds a predetermined threshold value.

8. The content processing apparatus according to claim 6, wherein the topic detection unit determines an edge image in the telop area in each frame to be compared and determines the presence of a telop in the telop area on the basis of the comparison result of the edge images in the telop areas of the frames.

9. The content processing apparatus according to claim 8, wherein the topic detection unit determines an edge image in a telop area in each frame to be compared, determines that the telop has disappeared when the number of pixels in the edge image detected in the telop area significantly decreases, and determines that the same telop continues to appear when the change in the number of pixels is small.

10. The content processing apparatus according to claim 9, wherein, when the change in the number of pixels in the edge image detected in the telop area is small, the topic detection unit obtains the logical AND for each edge pixel corresponding to each edge image and determines that the telop has changed when the number of edge pixels in the resulting image has significantly decreased.

11. The content processing apparatus according to claim 6, wherein the topic detection unit determines telop appearance time from the detected telop start position and end position and determines a topic only when the appearance time of the telop is longer than a predetermined amount of time.

12. The content processing apparatus according to claim 6, wherein the topic detection unit determines whether or not the telop is essential on the basis of the size or positional information of the telop area in which a telop is detected in a frame.

13. A content processing method for processing video content including time-sequential image frames in a content processing system configured in a computer, the method comprising:
a scene-change detection step in which scene-change means included in the computer detects a scene-change point where the scene significantly changes due to switching of image frames in the video content to be processed;
a topic detection step in which topic detection means included in the computer detects whether or not a telop appears at the scene-change point using the frames before and after the scene-change point detected in the scene-change detection step and detects a section in which the same stationary telop appears in a plurality of continuous image frames before and after the scene-change point at where the telop is detected; and
an index storage step in which index storage means included in the computer stores index information related to the time of the section in which the same stationary telop detected in the topic detection step appears.

14. The method of processing video content according to claim 13, further comprising:
a playing step of playing and outputting a section from a start time to an end time represented by the index information of the corresponding video content when a topic is selected from the index information stored in the index storage step.

15. The content processing method according to claim 13, wherein, in the topic detection step, an average image of frames of a predetermined period before and ending after the scene-change point is produced, and telop detection is carried out on the average image.

16. The content processing method according to claim 15,
wherein in the topic detection step,
telop areas of frames forward of the scene-change point are compared and a frame immediately after the frame in which the telop disappears from the telop area is detected as a start position of a topic and
telop areas of frames rearward of the scene-change point are compared and a frame immediately before the frame in which the telop disappears from the telop area is detected as a end position of the topic.

17. The content processing method according to claim 16, wherein, in the topic detection step, the average color for each color component in the telop area of each frame to be compared is computed and the telop is determined to have disappeared from the telop area by determining whether or not the Euclidean distance of the average colors between the image frames exceeds a predetermined threshold value.

18. The content processing method according to claim 16, wherein, in the topic detection step, an edge image in the telop area in each frame to be compared is determined and the presence of a telop in the telop area is determined on the basis of the comparison result of the edge images in the telop areas of the frames.

19. The content processing method according to claim 18, wherein, in the topic detection step, an edge image in a telop area in each frame to be compared is determined, the disappearance of the telop is determined when the number of pixels in the edge image detected in the telop area significantly decreases, and continuous appearance of the same telop is determined when the change in the number of pixels is small.

20. The content processing method according to claim 19, wherein, in the topic detection step, when the change in the number of pixels in the edge image detected in the telop area is small, the logical AND for each edge pixel corresponding to each edge image is obtained and a change in the telop is determined when the number of edge pixels in the resulting image has significantly decreased.

21. The content processing method according to claim 16, wherein, in the topic detection step, telop appearance time is determined from the detected telop start position and end position and a topic is determined only when the appearance time of the telop is longer than a predetermined amount of time.

22. The content processing method according to claim 16, wherein, in the topic detection step, whether or not the telop is essential is determined on the basis of the size or positional information of the telop area in which a telop is detected in a frame.

23. A computer program written in a format readable by a computer so as to carry out processing on video content including chronologically ordered image frames on a computer system, the processing comprising:
a scene-change detection step of detecting a scene-change point where the scene significantly changes due to switching of image frames in the video content to be processed;
a topic detection step of detecting whether or not a telop appears at the scene-change point using the frames before and after the scene-change point detected in the scene-change detection step and detects a section in which the same stationary telop appears in a plurality of continuous image frames before and after the scene-change point at where the telop is detected; and
an index storage step of storing index information related to the time of the section in which the same stationary telop detected in the topic detection step appears.
a playing step of playing and outputting a section from a start time to an end time represented by the index information of the corresponding video content when a topic is selected from the index information stored in the index storage step.
